(19) United States
(12) Patent Application Publication
(10) Pub. No.: US 2008/0103936 A1
(43) Pub. Date: May 1, 2008

(54) AUTOMATED DECISION ASSISTANT

(75) Inventors: Joshua M. Churlik, Westminster, CO (US); James M. Terry, Denver, CO (US); Paul M. James, Denver, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Simple Decisions Inc., Denver, CO (US)

(21) Appl. No.: 11/923,099

(22) Filed: Oct. 24, 2007

Related U.S. Application Data
(60) Provisional application No. 60/863,089, filed on Oct. 26, 2006.

(51) Int. Cl. G06Q 30/00; G06F 17/00

(52) U.S. Cl. 705/27

(57) ABSTRACT

Embodiments of the invention provide methods and systems for or providing automated assistance in making a decision such as selecting a product when shopping. According to one embodiment, a method of providing automated decision assistance can comprise presenting a user interface for selecting between a plurality of products identified in a product catalog. A question and answer session can be conducted via the user interface. Each question in the question and answer session can be selected based on a current context of the question and answer session and a relevance of each of the plurality of products identified in the product catalog to the current context of the question and answer session. At least one of the plurality of products identified in the product catalog can be suggested via the user interface based on results of the question and answer session.

### CROSS-REFERENCES TO RELATED APPLICATIONS

This application claims the benefit of U.S. Provisional Application No. 60/863,089, filed Oct. 26, 2006, entitled AUTOMATED SHOPPING ASSISTANT, the complete disclosure of which is herein incorporated by reference in its entirety for all purposes.

### BACKGROUND OF THE INVENTION

Embodiments of the present invention relate generally to computers and software and more particularly to methods and systems for providing an automated decision assistant.

Consumers often do not have the broad knowledge base for the particular product (or service) they are seeking to purchase, and therefore consumers typically will enlist the assistance of a salesperson. The salesperson may have the knowledge and expertise to assist the consumer in making an appropriate selection based on any of a wide variety of factors such as product features, price, availability, etc. Unfortunately, from the consumer's perspective, salespeople may be busy with other customers or may not have the detailed product knowledge the consumer expects. From the retailer's perspective, salespeople require a salary, commission, and/or other benefits that cost the retailer money, and the retailer often must pay the salespeople even if there are no sales. In addition, retailers may be hard pressed to hire experienced sales people during peak sales seasons (e.g., the holiday seasons).

Although automated solutions are available (e.g., product selection guides available via commercial web sites), these are limited in nature. In such automated solutions, the consumer makes selections from various fixed categories based on features the consumer believes are what he wants. For example, the consumer can select a category such as “home electronics” from a web page or other interface presenting a number of different categories as options. In response, a number of subcategories such as “video,” “audio,” “computers,” etc. may be displayed. Upon selection of one of these subcategories, further subcategories such as “desktops,” “laptops,” “PDAs,” etc. can be presented. Through such a process, the selections get ever-narrower until a short list of products is displayed for the user. However, if none of these products meet the consumer's expectations, the consumer has to start over or navigate backwards through the previously presented and selected categories to drill down into another category and/or subcategory.

Some current solutions seek to aid this process by querying the user as to his intentions. These queries can take the form of a question which, based on the user response, can be used to narrow the categories presented. However, while posing such questions may give the consumer the impression that results of such a process are tailored to his intentions, they still follow a rigid, fixed set of increasingly narrow categories and subcategories. That is, such processes still follow a decision tree type process wherein a user response is applied to a decision node of the decision tree and a branch followed based on the answer. Thus, the categories and subcategories represented by the branches of the tree are narrowed until a short list of products is displayed for the user.

As noted, such processes based on a decision tree representing increasingly narrow categories and subcategories are rigid and do not allow flexibility based on the answer or answers given thus far. The questions posed by such a process are also fixed. That is, once a particular node in the decision tree is reached, the predefined question for that node will be asked each time. Then, based on the response, branches of the decision tree and the categories, subcategories, and/or products represented thereby will be eliminated from further consideration unless the user navigates backwards and changes his selections. That is, such processes based on a decision tree do not replicate the type of help that can be provided by a human salesperson when applying knowledge and expertise to assist the consumer in making an appropriate selection based on any of a wide variety of factors such as, e.g., product features, price, availability, etc.

Furthermore, when dealing with a very large product catalog, the decision tree can be very large and difficult to navigate. The consumer may then find that once the products in a particular subcategory are presented, they are not at all what is desired, causing the consumer to back up or repeat a lengthy process to try different selections. Thus, the inflexibility presented by such decision tree based processes can be time consuming and frustrating to the consumer. Hence, there is a need in the art for improved methods and systems for providing automated shopping assistance.

### BRIEF SUMMARY OF THE INVENTION

Embodiments of the invention provide methods and systems for or providing automated assistance in making a decision such as selecting a product when shopping. According to one embodiment, a method of providing automated decision assistance can comprise presenting a user interface for selecting between a plurality of products identified in a product catalog. A question and answer session can be conducted via the user interface. For example, conducting the question and answer session and suggesting at least one of the plurality of products identified in the product catalog are performed in response to receiving a request for assistance via the user interface. Each question in the question and answer session can be selected based on a current context of the question and answer session and a relevance of each of the plurality of products identified in the product catalog to the current context of the question and answer session. At least one of the plurality of products identified in the product catalog can be suggested via the user interface based on results of the question and answer session.

The product catalog can comprise information imported from a master database of product information. For example, the information imported from the master database of product information can comprise information related to products specific to a retailer.

Conducting the question and answer session can comprise identifying a product pool from the product catalog based on the current context of the question and answer session. A relevance for each of one or more answers associated with one or more products of the product pool can be determined. A relevance for each of one or more questions associated with one or more of the one or more answers can also be determined. A most relevant question of the one or more questions can be presented via the user interface. Conducting the question and answer session can further comprise receiving an answer to the most relevant question via the user interface and updating the product pool based on the answer.

Suggesting at least one of the plurality of products can comprise generating a closing statement. For example, generating the closing statement can comprise combining one or more questions with one or more answers of the question and answer session in a sentence format.

According to another embodiment, a system for providing automated decision assistance can comprise a data repository adapted to maintain a product catalog and a decision engine communicatively coupled with the data repository. The decision engine can be adapted to present a user interface for selecting between a plurality of products identified in the product catalog and conduct a question and answer session via the user interface. For example, the decision engine conducts the question and answer session and suggests at least one of the plurality of products identified in the product catalog in response to receiving a request for assistance via the user interface. Each question in the question and answer session can be selected based on a current context of the question and answer session and a relevance of each of the plurality of products identified in the product catalog to the current context of the question and answer session. The decision engine can be adapted to suggest at least one of the plurality of products identified in the product catalog via the user interface and based on results of the question and answer session.

The product catalog can comprise information imported from a master database of product information. For example, the information imported from the master database of product information can comprise information related to products specific to a retailer.

The decision engine can be adapted to conduct the question and answer session by identifying a product pool from the product catalog based on the current context of the question and answer session, determining a relevance for each of one or more answers associated with one or more products of the product pool, determining a relevance for each of one or more questions associated with one or more of the one or more answers, and presenting a most relevant question of the one or more questions via the user interface. The decision engine can be further adapted to receive an answer to the most relevant question via the user interface and update the product pool based on the answer.

Suggesting at least one of the plurality of products can comprise generating a closing statement. For example, generating the closing statement can comprise combining one or more questions with one or more answers of the question and answer session in a sentence format.

According to yet another embodiment, a machine-readable medium can have stored thereon a series of instruction which, when executed by a processor, cause the processor to provide automated decision assistance by presenting a user interface for selecting between a plurality of products identified in a product catalog. A question and answer session can be conducted via the user interface. For example, conducting the question and answer session and suggesting at least one of the plurality of products identified in the product catalog are performed in response to receiving a request for assistance via the user interface. Each question in the question and answer session can be selected based on a current context of the question and answer session and a relevance of each of the plurality of products identified in the product catalog to the current context of the question and answer session. At least one of the plurality of products identified in the product catalog can be suggested via the user interface based on results of the question and answer session.

The product catalog can comprise information imported from a master database of product information. For example, the information imported from the master database of product information can comprise information related to products specific to a retailer.

Conducting the question and answer session can comprise identifying a product pool from the product catalog based on the current context of the question and answer session. A relevance for each of one or more answers associated with one or more products of the product pool can be determined. A relevance for each of one or more questions associated with one or more of the one or more answers can also be determined. A most relevant question of the one or more questions can be presented via the user interface. Conducting the question and answer session can further comprise receiving an answer to the most relevant question via the user interface and updating the product pool based on the answer.

Suggesting at least one of the plurality of products can comprise generating a closing statement. For example, generating the closing statement can comprise combining one or more questions with one or more answers of the question and answer session in a sentence format.

### BRIEF DESCRIPTION OF THE DRAWINGS

FIG. 1 is a block diagram illustrating, at a high level, elements of a system for providing automated decision assistance according to one embodiment of the present invention.

FIG. 2 is a block diagram illustrating an exemplary computer system upon which embodiments of the present invention may be implemented.

FIG. 3 is a block diagram conceptually illustrating a process for importing a product catalog according to one embodiment of the present invention.

FIG. 4 is a flowchart illustrating a process for providing automated decision assistance according to one embodiment of the present invention.

FIG. 5 is a flowchart illustrating a process for conducting a question and answer session according to one embodiment of the present invention.

### DETAILED DESCRIPTION OF THE INVENTION

In the following description, for the purposes of explanation, numerous specific details are set forth in order to provide a thorough understanding of various embodiments of the present invention. It will be apparent, however, to one skilled in the art that embodiments of the present invention may be practiced without some of these specific details. In other instances, well-known structures and devices are shown in block diagram form.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “machine-readable medium” includes, but is not limited to portable or fixed storage devices, optical storage devices, wireless channels and various other mediums capable of storing, containing or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

The following definitions are provided to assist the reader in understanding specific language used herein. However, it is not intended that these definitions be limiting. All terminology should still be given its ordinary meaning when possible, and the following definitions used only where such ordinary meaning conflicts with a reasonable interpretation of the invention.

The term “item” as used herein refers to an entity or object that that is the subject of a decision. In embodiments related to providing shopping assistance, i.e., when providing assistance in choosing between various products and/or services, an item can be any product or service offered by a retailer, merchant, or other entity, and can extend to virtually any other qualifying entity.

A “catalog” can be defined as a collection of items which represents available items from which a user can choose. In a shopping context, a catalog can represent the goods and/or services available from a particular retailer or merchant or group of retailers or merchants. The term “product pool” is also used herein to refer to a collection of available items. While the terms catalog and product pool can be considered to be generally synonymous, it should be understood that in some cases, a product pool may represent a subset or superset of a catalog.

The term “category” refers to any suitable means to group items within a catalog or product pool.

A “specification” can be a detailed description of a particular item to which it relates. Items within a catalog or product pool can have one or more specifications that are specific to that item, but not necessarily exclusive to that item.

The term “attribute” refers to one or more data elements representing an abstraction of a catalog or product pool. An attribute can be associated with items, but may also be associated with categories or a catalog. Attributes may be derived directly from the item's specification, but may also be arbitrarily assigned. Items and attributes may have multiple relationships and may be shared. An attribute may also inherit from other attributes based on these relationships. In use, attributes can provide an abstraction of the items and/or catalogs upon which a decision process can make suggestions.

The term “criterion” or “criteria” refers to a discrete step in making a selection from a catalog based on the contained items' and categories' attributes. The criteria may indicate what the object is, is not, or as being not applicable to the selection. Criteria can be defined in terms of a question posed to the user in a decision process and the answer to the question provided by the user.

Criteria may be organized into “recipes,” which create an ordered list of criteria. Thus, the recipe can represent a flow of a decision making or item selection process. A recipe for a particular decision making process can include for each step of the process the questions posed to the user and the answers returned. According to one embodiment, the recipe for the process can also include an indication of a product pool for each step of the process.

The term “dialogue” can refer to a discrete step in a selection criteria, i.e., the question.

The term “suggestion” refers to an item or item selected from the catalog based on a decision process. A suggestion may be presented as a list of items derived from the catalog or product pool based on the recipe.

The term “selection” refers to an item chosen by the user from the suggestion(s).

Furthermore, although the terms “consumer” and “retailers” are used herein by way of example, it is understood that the systems and methods disclosed may be used by consumers, shoppers, potential customers, retailers, suppliers, or other users, merchants, or other entities. This terminology is not intended to be limiting, but rather illustrative of a particular implementation. Additionally, it should be understood that, while described herein with reference to a shopping assistant embodiment, other embodiments can be implemented to assist other decision making processes. Accordingly, embodiments of the present invention are thought to be applicable to any decision making process in which a user can be provided assistance in making a selection from multiple available options. In such embodiment, the term consumer can be replaced with the term decider or decision maker. Similarly, rather than a retailer and/or merchants and goods and/or services, the items selected by the decision maker can represent any number and/or type of option which may or may not be provided by, supported by, or related to another entity.

Generally speaking, embodiments of the present invention provide methods and systems for implementing an automated decision assistant. In exemplary embodiments, the automated decision assistant, such as an automated shopping assistant, may be implemented in program code (e.g., software) executing on one or more computer systems (e.g., personal computer or PC, kiosk, server computer via a network such as the Internet, etc.). The program code may execute a user interface (e.g., a graphical user interface or GUI such as a web page or other interface) which replicates or approximates dialog a consumer may have with a live salesperson.

The program code may also execute a decision engine which asks questions of the consumer and determines a relevance of products (or services) to the consumer's criteria based on attributes the decision engine finds in common with products (or services) in a database. During this time, the decision engine can also build a recipe for the decision process. The recipe can include the consumer's criteria represented in the form of a question posed to the consumer and the corresponding answer supplied by the consumer. As such the recipe can represent a flow of the decision making process. Accordingly, the automated shopping assistant can recommend products (or services) that meet the consumer's criteria. The recommendation can be based on the consumer's criteria represented in the recipe, as well as attributes for the products.

In the event such products (or services) do not meet the consumer's criteria, the automated shopping assistant may automatically or upon request by the consumer back-step (or jump) to previous questions to find a product (or service) that does meet the consumer's criteria without the consumer having to start over at the beginning. The automated sales assistant may also recommend related products, e.g., which compliment the recommended products and/or other products being viewed at the item level. For example, gloves and hats may be recommended as related products to a coat or jacket.

Thus, an exemplary automated shopping assistant can provide a consumer-centric shopping experience (e.g., the consumer may feel as though he is interacting with a live personal sales representative). In addition, the results of the consumer's interaction with the automated shopping assistant may be saved, e.g., so that the consumer does not have to start over if the recommended products (or services) do not meet his/her criteria, for later use by the same consumer and/or retailer data analysis, etc.

In some embodiments, scan to compare/decide technology may be implemented which enables consumers to compare all of the products held in their hands, e.g., by scanning each product's UPC or RFID tag in succession or by using other means and/or techniques of product identification. Accordingly, consumers may compare a product from the shelf to the automated shopping assistant's recommendation by scanning the product's UPC or RFID tag and possibly by engaging in a question and answer session with the automated shopping assistant to determine the consumer's criteria and for making a suggestion based thereon. The product information may also be presented in an orderly form and provide the option of selecting an individual product from the list to access more detailed product information. Additional details of the various embodiments will be discussed below with reference to the figures.

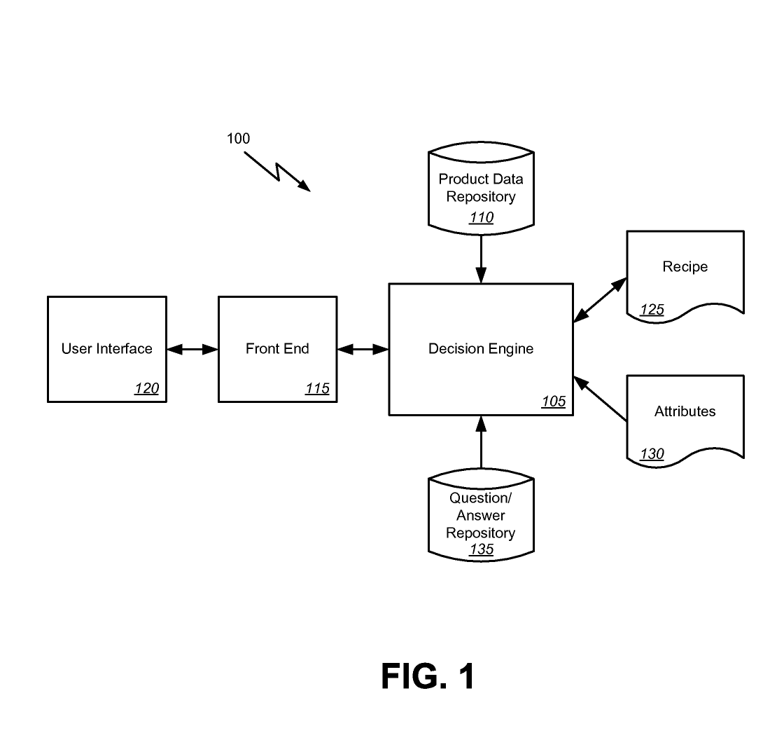

FIG. 1 is a block diagram illustrating, at a high level, elements of a system for providing automated shopping assistance according to one embodiment of the present invention. As noted the elements of this system 100 may be implemented in hardware, software, or a combination of hardware and software. Regardless of how the elements are implemented, the system 100 can include a user interface 120 (e.g., a graphical user interface or GUI) which replicates or closely replicates dialog a consumer may have with a live salesperson. The user interface 120 can be supported by and/or communicate with a front end 115 such as a web server or other system. Furthermore, the user interface 120 can take any of a variety of forms without departing from the scope if the present invention. For example, the user interface 120 can comprise one or more web pages served by a web server or other front end 115. In other implementations, the user interface may comprise a client application executing on a mobile device in communication with the front end 115. In yet other implementations, the user interface can comprise a kiosk or other system installed in a retail location for use by consumers. In yet other implementations, the front end 115 may be excluded and/or the functions provided by the front end, i.e., supporting the presentation of the user interface 120, can be performed by other elements of the system 100.

The system can also include a product data repository 110. The product data repository can include a catalog of product information. It is noted that the product data repository 110 may be specifically generated for use with the system 100, and/or may be integrated with a retailer's and/or supplier's existing database. That is, the product data repository 110 may be store-specific, or may be implemented among a plurality of different stores (e.g., stores registering with the automated shopping assistant). As noted above, various embodiments of the present invention may be directed to decision making processes other than shopping. In such cases, the product data repository 110 can comprise any repository of information representing or directed to items from which or upon which a decision or selection is to be made.

The system 100 can also include a decision engine 105 in communication with the user interface 120 and/or the front end 115. As will be described in detail below, the decision engine can conduct a question and answer session with a user via the user interface 120. The question and answer session can comprise the decision engine asking qualifying questions, for example defined in a question/answer repository 135, of the consumer to build a recipe 125. As noted above, the recipe 125 can comprise an ordered list of criteria, i.e., questions and corresponding answers, representing a flow of a decision making or item selection process, i.e., the question and answer session. Thus, a recipe 125 for a particular decision making process can include for each step of the process the questions posed to the user and the answers returned.

In any event, the recipe 125 can be user-specific, i.e., specific to the question and answer session, and may include or identify products, services, or other items that meet the consumer's criteria, attributes of these products, services), or other items and questions which led to these products, services, or other items being recorded in the recipe (i.e., the consumer's criteria), among other data.

Accordingly, the decision engine 105 can recommend products, services, or other items that meet the consumer's criteria. In the event such products, services, or other items do not meet the consumer's criteria, the decision engine 105 may back-step (or jump) to previous questions identified in the recipe 125 to find a product, service, or other item that does meet the consumer's criteria without the consumer having to start over at the beginning.

Stated another way, a system 100 for providing automated decision assistance can comprise a data repository 110 adapted to maintain a product catalog and a decision engine 105 communicatively coupled with the data repository 110. The decision engine 105 can be adapted to present a user interface 120, either directly or via a front end 115, for selecting between a plurality of products identified in the product catalog. The decision engine 105 can conduct a question and answer session via the user interface. For example, the decision engine conducts the question and answer session with a user via the user interface 120 and suggest at least one of the plurality of products identified in the product catalog stored in the product data repository 110 in response to receiving a request for assistance via the user interface 120. Each question in the question and answer session can be selected based on a current context of the question and answer session and a relevance of each of the plurality of products identified in the product catalog to the current context of the question and answer session. The decision engine 105 can be adapted to suggest at least one of the plurality of products identified in the product catalog of the product data repository 110 via the user interface 120 and based on results of the question and answer session.

More specifically, the decision engine 105 can be adapted to conduct the question and answer session by identifying a product pool or a relevant subset from the product catalog stored in the product data repository 110 based on the current context of the question and answer session. The current context of the question and answer session can be determined based on the recipe 125 and the most recent question and answer combination therein. However, in the event of an initial determination of the current context, i.e., upon initiation of the question and answer session, the context can be determined in other ways. For example, the initial context may be based on a category of products selected by the user via the user interface 120 or by a product identified via the user interface, for example by scanning the product or selecting the product from a list. In some cases, the initial context may comprise the entire product catalog in which case a generic initial question may be selected.

Once a current context has been determined, the decision engine 105 can determine a relevance for each of one or more answers associated with one or more products of the product pool, for example based on a relational mapping between the products and the questions and answers and/or one or more attributes 130 defining such abstract concepts as a rating, i.e., good, better, best, and other logic such as an indication of whether the product is in stock etc. The decision engine 105 can also determine a relevance for each of one or more questions associated with one or more of the one or more answers based on a relational mapping of the questions and answers stored in the question/answer data repository 135. The decision engine 105 can then present the most relevant question of the one or more questions via the user interface 120. The decision engine 105 can be further adapted to receive an answer to the most relevant question via the user interface 120 and update the product pool based on the answer. The decision engine 105 can then further iterate through such a decision process until a product or small set of products are identified. At such a time, the decision engine 105 can recommend such one or small set of products to the user.

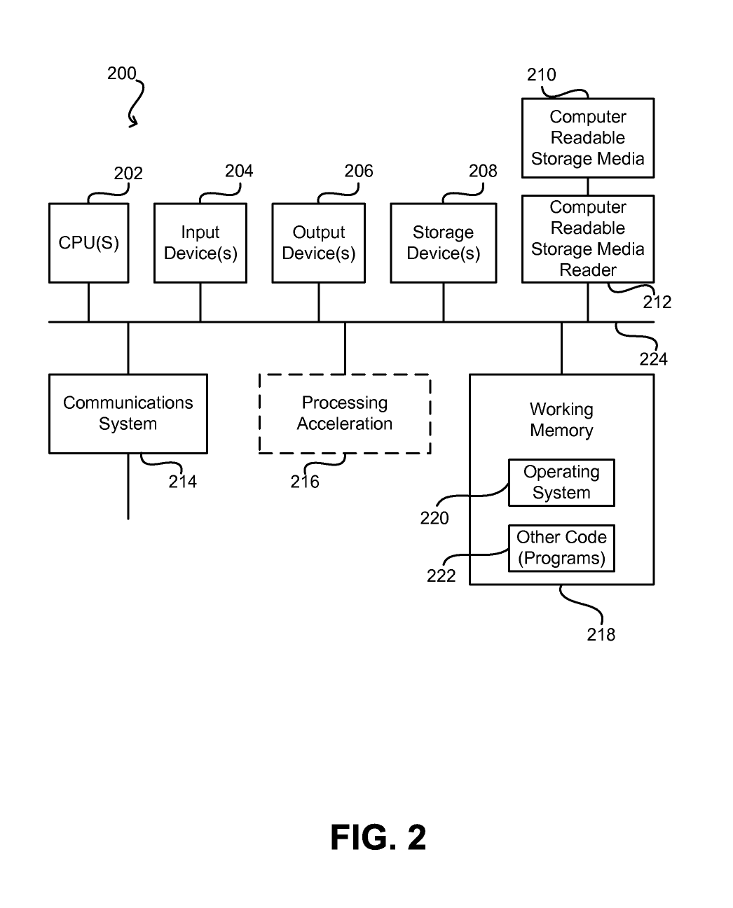

It should be noted that embodiments of the present invention may be implemented by software executed by a general purpose or dedicated computer system. FIG. 2 is a block diagram illustrating an exemplary computer system upon which embodiments of the present invention may be implemented. In this example, the computer system 200 is shown comprising hardware elements that may be electrically coupled via a bus 224. The hardware elements may include one or more central processing units (CPUs) 202, one or more input devices 204 (e.g., a mouse, a keyboard, microphone, etc.), and one or more output devices 206 (e.g., a display device, a printer, etc.). The computer system 200 may also include one or more storage devices 208. By way of example, the storage device(s) 208 can include devices such as disk drives, optical storage devices, solid-state storage device such as a random access memory (“RAM”) and/or a read-only memory (“ROM”), which can be programmable, flash-updateable and/or the like.

The computer system 200 may additionally include a computer-readable storage media reader 212, a communications system 214 (e.g., a modem, a network card (wireless or wired), an infra-red communication device, etc.), and working memory 218, which may include RAM and ROM devices as described above. In some embodiments, the computer system 200 may also include a processing acceleration unit 216, which can include a digital signal processor DSP, a special-purpose processor, and/or the like.

The computer-readable storage media reader 212 can further be connected to a computer-readable storage medium 210, together (and, optionally, in combination with storage device(s) 208) comprehensively representing remote, local, fixed, and/or removable storage devices plus storage media for temporarily and/or more permanently containing computer-readable information. The communications system 214 may permit data to be exchanged with the network and/or any other computer described above with respect to the system 200.

The computer system 200 may also comprise software elements, shown as being currently located within a working memory 218, including an operating system 220 and/or other code 222, such as an application program (which may be a client application, Web browser, mid-tier application, RDBMS, etc.). It should be appreciated that alternate embodiments of a computer system 200 may have numerous variations from that described above. For example, customized hardware might also be used and/or particular elements might be implemented in hardware, software (including portable software, such as applets), or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, data signals, data transmissions, or any other medium which can be used to store or transmit the desired information and which can be accessed by the computer. Based on the disclosure and teachings provided herein, a person of ordinary skill in the art will appreciate other ways and/or methods to implement the various embodiments.

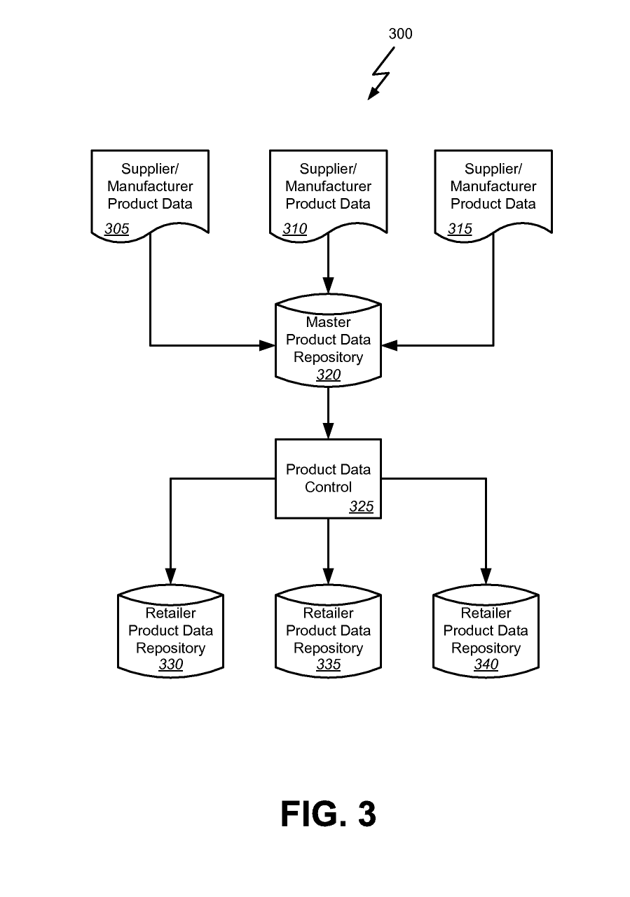

FIG. 3 is a block diagram conceptually illustrating a process for importing a product catalog according to one embodiment of the present invention. As noted above, the product catalog stored in the product data repository can comprise information imported from a master database of product information. For example, the information imported from the master database of product information can comprise information related to products specific to a retailer.

As illustrated here, supplier or manufacture product data 305-315 can be supplied to and stored in a master product data repository 320. A product data control process 325 can then read all or some subset of all of the product data in the master product data repository 320 and store such information, as appropriate, in one or more retailer specific product data repositories 330-340. For example, the retailer specific product data repositories 330-340 can be updated based on product order or other information provided by the retailers.

This system 300 creates a data flow from product suppliers into the product inventory databases. Data templates may be used to identify incoming data formats from any external source. These templates enable the system to identify incoming data with little or no human interaction. This data may be aggregated into the master product data repository 320 and updates may then be rolled out to retailer specific product data repositories 330-340 as automatic updates.

The process may also utilize purchase orders and inventory orders placed by retailers with their suppliers to sort imported product information. The order information (e.g., a mfg model number, mfg SKU numbers, or some other unique identification) indicates which products have been ordered and allows the product data control process 325 to sort supplier product information into the appropriate retailer specific product data repositories 330-340.

Additionally or alternatively, rather than populated retailer specific product data repositories 330-340 the system 300 may instead use the same identification method to control access to product instances in a master product data repository 320. This process may be implemented for a multitude of industries managing product information.

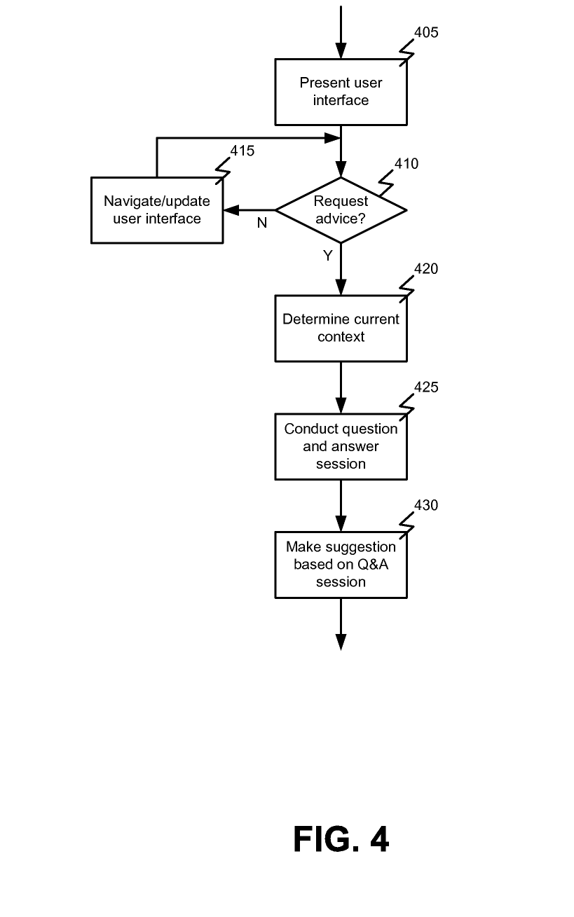

FIG. 4 is a flowchart illustrating a process for providing automated shopping assistance according to one embodiment of the present invention. In this example, the process begins with presenting 405 a user interface for selecting between a plurality of products identified in a product catalog. A determination 410 can be made as to whether assistance is requested. In response to determining 410 that assistance is not requested, the user interface can be navigated and/or updated 415 accordingly. That is, the user can be allowed to continue to navigate the user interface.

In response to determining 410 that assistance is requested, a current context can be determined 420. As noted above, determining 420 a current context can T can be determined based on the recipe and the most recent question and answer combination therein. However, in the event of an initial determination of the current context, i.e., upon initiation of the question and answer session, the context can be determined in other ways. For example, the initial context may be based on a category of products selected by the user via the user interface or by a product identified via the user interface, for example by scanning the product or selecting the product from a list. In some cases, the initial context may comprise the entire product catalog in which case a generic initial question may be selected.

A question and answer session can be conducted 425 via the user interface. For example, conducting 425 the question and answer session and suggesting at least one of the plurality of products identified in the product catalog are performed in response to receiving a request for assistance via the user interface. Each question in the question and answer session can be selected based on a current context of the question and answer session and a relevance of each of the plurality of products identified in the product catalog to the current context of the question and answer session. At least one of the plurality of products identified in the product catalog can be suggested 430 via the user interface based on results of the question and answer session.

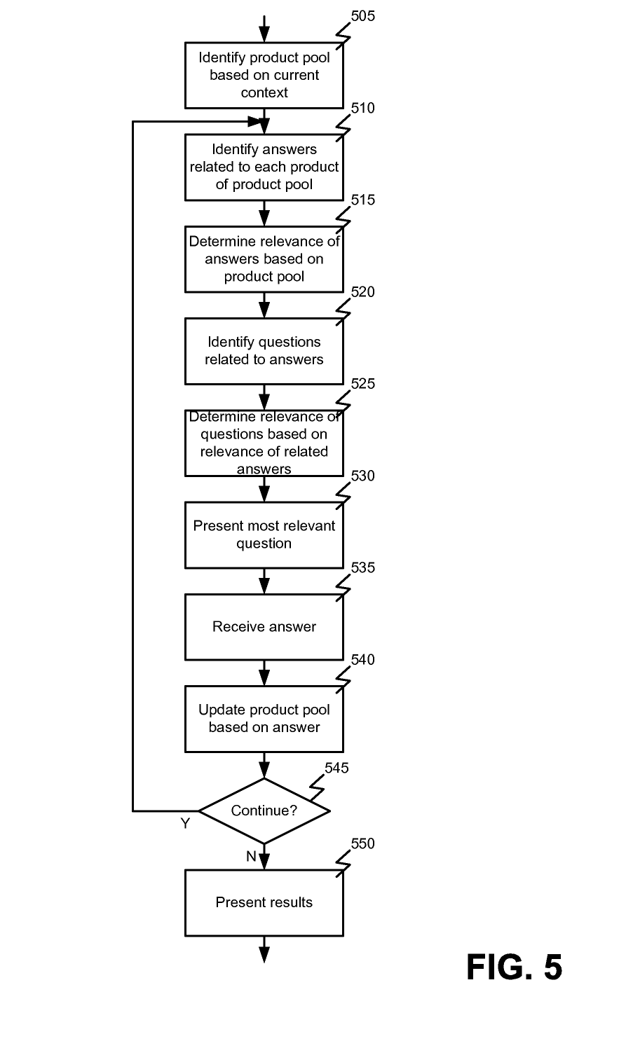

FIG. 5 is a flowchart illustrating a process for conducting a question and answer session according to one embodiment of the present invention. In this example, the process begins with identifying 505 a product pool from the product catalog based on the current context of the question and answer session. Identifying 505 the product pool can be based, for example, on a current product or product category.

One or more answers related to products in the product pool can be identified 510. Identifying 510 one or more answers related to products in the product pool can be based, for example, on a relational mapping between the products in the product pool and one or more answers and/or one or more attributes of the products. A relevance for each of one or more answers associated with one or more products of the product pool can be determined 515. Determining 515 the relevance of an answer can be based on determining a number of occurrences of that answer or based on another criteria.

One or more questions related to the identified answers can then be identified 520. Identifying one or more questions related to the identified answers can be based one a relational mapping between the questions and answers. A relevance for each of one or more questions associated with one or more of the one or more answers can also be determined 525. Determining 525 the relevance of a question can be based on determining a number of occurrences of that question or based on another criteria.

The most relevant question of the one or more questions can be presented 530 via the user interface. Conducting the question and answer session can further comprise receiving 535 an answer to the most relevant question via the user interface and updating 540 the product pool based on the answer. Updating 540 the product pool can comprise determining a current relevance of each product in the product pool based on the received 535 answer.

A determination 545 can be made as to whether to continue the question and answer session. The determination 545 can be based on any of a number of factors including but not limited to user input, achieving a product pool of a predetermined size, etc. In response to determining 545 to continue the session, processing can return to identifying 510 answers related to one or more products in the current product pool and continue for another iteration of the process.

In response to determining 545 not to continue the session, at least one of the plurality of products can be presented 550. That is, the one or some small group of the most relevant products can be presented to the user via the user interface. According to one embodiment, presenting 550 the product or products can comprise generating a closing statement. Generating the closing statement can comprise combining one or more questions with one or more answers of the question and answer session in a sentence format. For example, a closing statement may take the form “Since you indicated that you are looking for [criteria 1] with [criteria 2] and [criteria 3], we recommend [product X].” In this example, the criteria can be filled with answers provided by the user during the session and stored in the recipe. Of course other combinations of questions and answers in different formats and styles are contemplated and considered to be within the scope of the present invention.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1. A method of providing automated decision assistance, the method comprising:
presenting a user interface for selecting between a plurality of products identified in a product catalog;
conducting a question and answer session via the user interface, wherein each question in the question and answer session is selected based on a current context of the question and answer session and a relevance of each of the plurality of products identified in the product catalog to the current context of the question and answer session; and
suggesting at least one of the plurality of products identified in the product catalog via the user interface and based on results of the question and answer session.

2. The method of claim 1, wherein conducting the question and answer session and suggesting at least one of the plurality of products identified in the product catalog are performed in response to receiving a request for assistance via the user interface.

3. The method of claim 1, wherein the product catalog comprises information imported from a master database of product information.

4. The method of claim 3, wherein the information imported from the master database of product information comprises information related to products specific to a retailer.

5. The method of claim 1, wherein conducting the question and answer session comprises:
identifying a product pool from the product catalog based on the current context of the question and answer session;
determining a relevance for each of one or more answers associated with one or more products of the product pool;
determining a relevance for each of one or more questions associated with one or more of the one or more answers; and
presenting a most relevant question of the one or more questions via the user interface.

6. The method of claim 5, wherein conducting the question and answer session further comprises:
receiving an answer to the most relevant question via the user interface; and
updating the product pool based on the answer.

7. The method of claim 1, wherein suggesting at least one of the plurality of products comprises generating a closing statement.

8. The method of claim 7, wherein generating the closing statement comprises combining one or more questions with one or more answers of the question and answer session in a sentence format.

9. A system for providing automated decision assistance, the system comprising:
a data repository adapted to maintain a product catalog; and
a decision engine communicatively coupled with the data repository and adapted to present a user interface for selecting between a plurality of products identified in the product catalog, conduct a question and answer session via the user interface, wherein each question in the question and answer session is selected based on a current context of the question and answer session and a relevance of each of the plurality of products identified in the product catalog to the current context of the question and answer session, and suggest at least one of the plurality of products identified in the product catalog via the user interface and based on results of the question and answer session.

10. The system of claim 9, wherein the decision engine conducts the question and answer session and suggests at least one of the plurality of products identified in the product catalog in response to receiving a request for assistance via the user interface.

11. The system of claim 9, wherein the product catalog comprises information imported from a master database of product information.

12. The system of claim 11, wherein the information imported from the master database of product information comprises information related to products specific to a retailer.

13. The system of claim 9, wherein the decision engine is adapted to conduct the question and answer session by:
identifying a product pool from the product catalog based on the current context of the question and answer session;
determining a relevance for each of one or more answers associated with one or more products of the product pool;
determining a relevance for each of one or more questions associated with one or more of the one or more answers; and
presenting a most relevant question of the one or more questions via the user interface.

14. The system of claim 13, wherein the decision engine is further adapted to:
receive an answer to the most relevant question via the user interface; and
update the product pool based on the answer.

15. The system of claim 9, wherein suggesting at least one of the plurality of products comprises generating a closing statement.

16. The system of claim 15, wherein generating the closing statement comprises combining one or more questions with one or more answers of the question and answer session in a sentence format.

17. A machine-readable medium having stored thereon a series of instruction which, when executed by a processor, cause the processor to provide automated decision assistance by:
presenting a user interface for selecting between a plurality of products identified in a product catalog;
conducting a question and answer session via the user interface, wherein each question in the question and answer session is selected based on a current context of the question and answer session and a relevance of each of the plurality of products identified in the product catalog to the current context of the question and answer session; and
suggesting at least one of the plurality of products identified in the product catalog via the user interface and based on results of the question and answer session.

18. The machine-readable medium of claim 17, wherein conducting the question and answer session and suggesting at least one of the plurality of products identified in the product catalog are performed in response to receiving a request for assistance via the user interface.

19. The machine-readable medium of claim 17, wherein the product catalog comprises information imported from a master database of product information.

20. The machine-readable medium of claim 19, wherein the information imported from the master database of product information comprises information related to products specific to a retailer.

21. The machine-readable medium of claim 17, wherein conducting the question and answer session comprises:
identifying a product pool from the product catalog based on the current context of the question and answer session;
determining a relevance for each of one or more answers associated with one or more products of the product pool;
determining a relevance for each of one or more questions associated with one or more of the one or more answers; and
presenting a most relevant question of the one or more questions via the user interface.

22. The machine-readable medium of claim 21, wherein conducting the question and answer session further comprises:
receiving an answer to the most relevant question via the user interface; and
updating the product pool based on the answer.

23. The machine-readable medium of claim 17, wherein suggesting at least one of the plurality of products comprises generating a closing statement.

24. The machine-readable medium of claim 23, wherein generating the closing statement comprises combining one or more questions with one or more answers of the question and answer session in a sentence format.
